(19) United States
(12) Patent Application Publication
(10) Pub. No.: US 2016/0001708 A1
(43) Pub. Date: Jan. 7, 2016

(54) MOUNTING SYSTEM FOR MOBILE DEVICES

(71) Applicants: Omar Syed MAHMOOD, Dix Hills, NY (US); Adam Seth WEISINGER, Commack, NY (US)

(72) Inventors: Omar Syed MAHMOOD, Dix Hills, NY (US); Adam Seth WEISINGER, Commack, NY (US)

(21) Appl. No.: 14/788,706

(22) Filed: Jun. 30, 2015

Related U.S. Application Data
(60) Provisional application No. 62/020,223, filed on Jul. 2, 2014.

(51) Int. Cl. B60R 7/04

(52) U.S. Cl. CPC B60R 7/043

(57) ABSTRACT

A passenger seat mounting system adaptable for various and changing mobile technology is provided. The universal mounting system has an enclosure and a universal bracket assembly for securing to the various and changing mobile technology. The enclosure defines an enclosure cavity for said mobile technology, wherein the universal bracket assembly operatively engages the mobile technology through rear cutouts of the enclosure so that all three components are removably secured. The universal mounting system may be pivotally connected to supporting legs that are adapted to slide into standard head rest holes of a seat body. As the universal bracket assembly is adjustable, so are the varieties of mobile technology that can be universally mounted.

### CROSS-REFERENCE TO RELATED APPLICATION

This application claims the benefit of priority of U.S. provisional application No. 62/020,223, filed 2 Jul. 2014, the contents of which are herein incorporated by reference.

### BACKGROUND OF THE INVENTION

The present invention relates to mounting systems for mobile devices and, more particularly, to a passenger seat mounting system adaptable for various and changing mobile technology.

Mobile devices evolve frequently. Current passenger seat mounting systems, however, cannot keep up the pace. As a result, passengers wishing to view their own mobile devices by mounting them to the backside of the seat in front of them—via these pre-existing mounting systems—are unable to do so as such mounting systems are geared only for certain, soon-to-be-outdated models.

As can be seen, there is a need for a passenger seat mounting system adaptable for various and changing mobile technology.

### SUMMARY OF THE INVENTION

In one aspect of the present invention, a universal mounting system for mounting a mobile device includes an enclosure forming an enclosure cavity, wherein a front portion of the enclosure is open and an opposing rear portion of the enclosure curves away from the front portion; two aligned, spaced apart elongated cutouts formed into the rear portion; and a universal bracket assembly having a plurality of brackets flanges, each providing a first portion joined to a second portion, wherein two bracket flanges attach to the rear portion so that each second portion protrudes through one of the two elongated cutouts.

In another aspect of the present invention, a universal mounting system for mounting a mobile device includes an enclosure forming an enclosure cavity, wherein a front portion of the enclosure is open and an opposing rear portion of the enclosure curves away from the front portion; two elongated cutouts formed into the rear portion, wherein the two cutouts are spaced apart and aligned along a central vertical axis; and a universal bracket assembly having a plurality of brackets flanges, each including a first portion joined to a second portion, wherein two bracket flanges attach to the rear portion so that each second portion protrudes through one of the two elongated cutouts; two removable fasteners for attaching the two first portions to the rear portion; and a bracket plate sandwiched between the two first portions and the rear portion; and two support legs pivotally connected to opposing sides of the enclosure, wherein the two support legs are dimensioned and adapted to slide into standard head rest holes of a seat body.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a top front perspective view of an exemplary embodiment of the present invention;

FIG. 3 is a rear bottom perspective view of an exemplary embodiment of the present invention;

FIG. 4 is a front view of an exemplary embodiment of the present invention;

FIG. 5 is a top view of an exemplary embodiment of the present invention;

FIG. 6 is a side view of an exemplary embodiment of the present invention; and

FIG. 7 is a section detail view of an exemplary embodiment of the present invention, taken along line 7-7 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a passenger seat mounting system adaptable for various and changing mobile technology. The universal mounting system has an enclosure and a universal bracket assembly for securing to the various and changing mobile technology. The enclosure defines an enclosure cavity for said mobile technology, wherein the universal bracket assembly operatively engages the mobile technology through rear cutouts of the enclosure so that all three components are removably secured. The universal mounting system may be pivotally connected to supporting legs that are adapted to slide into standard head rest holes of a seat body. As the universal bracket assembly is adjustable, so are the varieties of mobile technology that can be universally mounted.

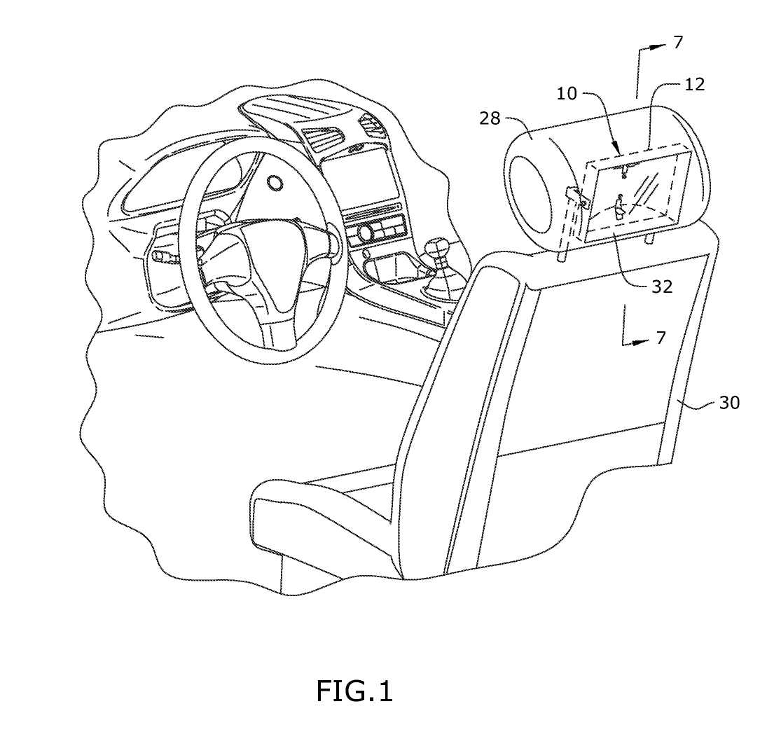

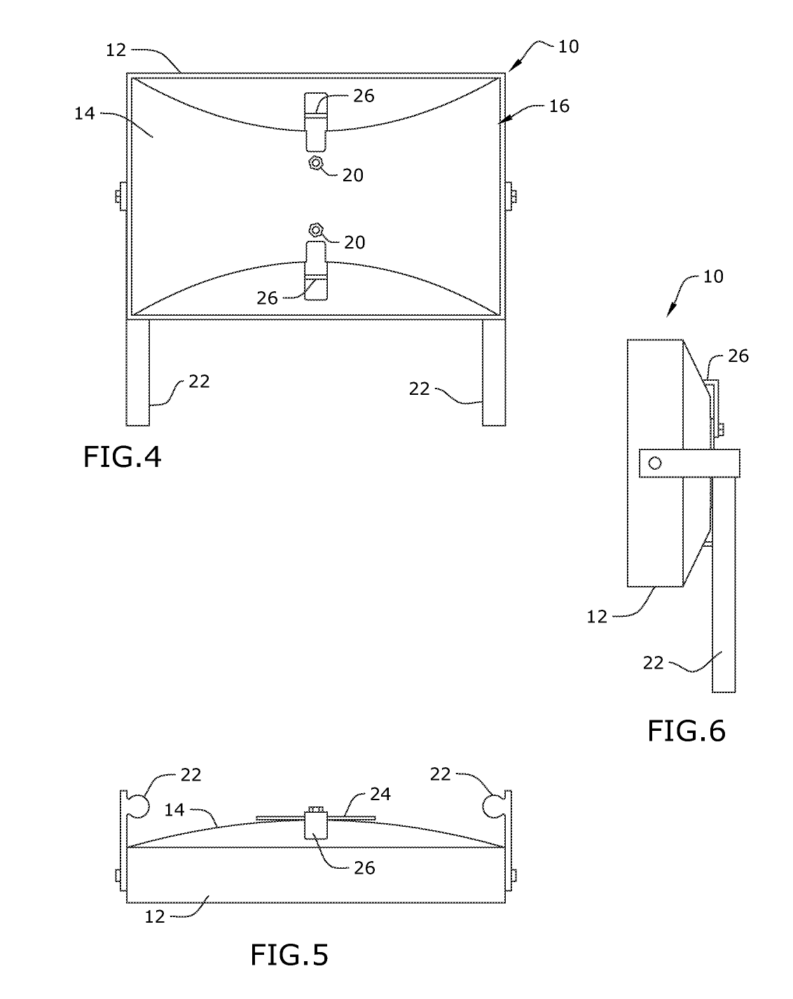

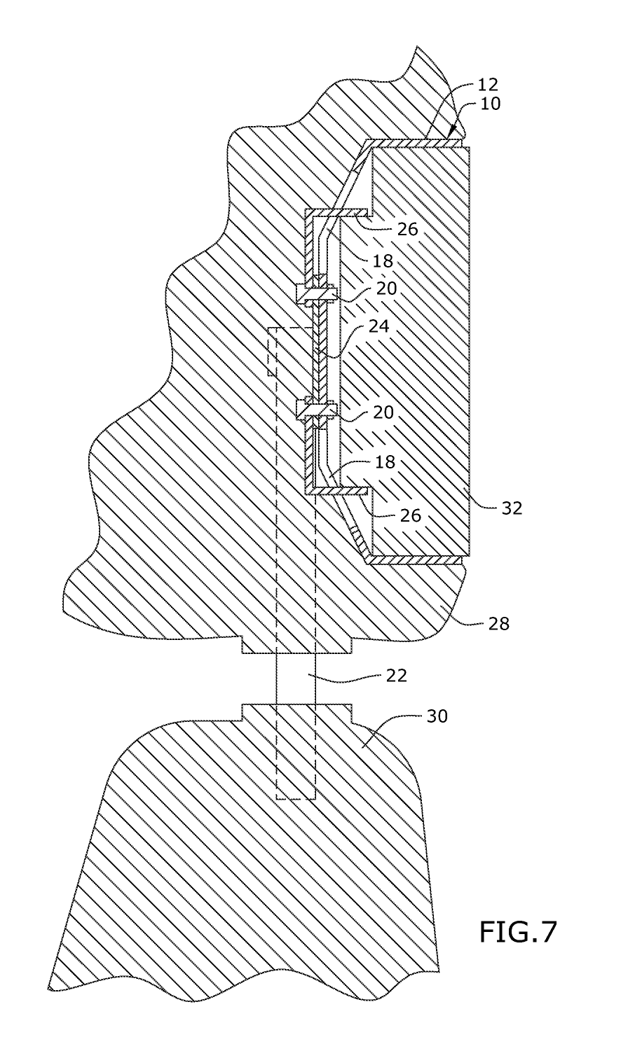

Referring to FIGS. 1 through 7, the present invention may include a universal mounting system 10 having an enclosure 12 and a universal bracket assembly 40. The enclosure 12 may be box-like, defining an enclosure cavity 16 and having an open front portion. Unlike most boxes, a rear portion 14 may be curved out, away from the enclosure cavity 16, thus providing additional capacity within the enclosure cavity 16 so as to be adaptable to various and changing sizes of a predetermined mobile device 32. The predetermined mobile device 32 can be a cell phone, tablet, laptop or any other portable electronic equipment.

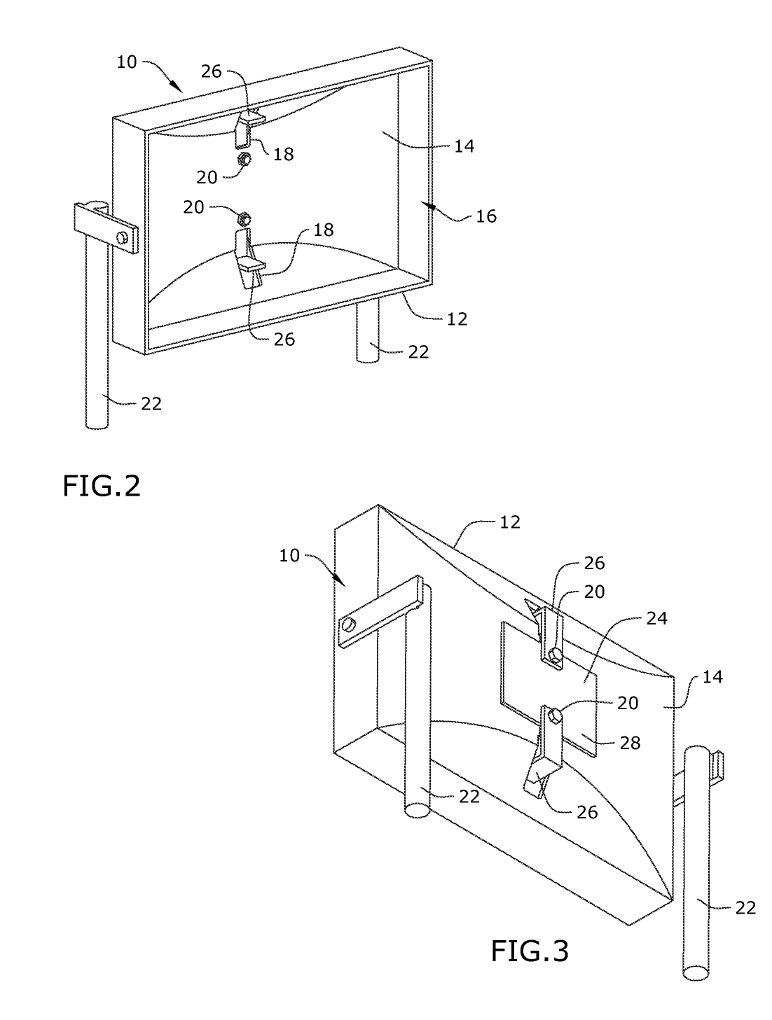

The rear portion 14 may form two elongated cutouts 18. The two elongated cutouts 18 may be generally aligned and spaced apart along a central vertical axis of the enclosure 12, as illustrated in FIGS. 2-4. The rear portion 14 may form a plurality of fastener holes between the two elongated cutouts 18.

The universal bracket assembly 40 may include a bracket plate 24, a plurality of bracket flanges 26 and two removable fasteners 20 to connect at least two bracket flanges 26 to the bracket plate 24 and through the fastener holes of the rear portion 14. Each bracket flange 26 has a first portion 34 joined to a second portion 36, wherein the first and second portions may be dimensioned and adapted so that the second portions 36 protrude through the two elongated cutouts 18 to operably engage a back portion 38 of the predetermined mobile device 32, as illustrated in FIG. 7. Operative engagement includes securing the predetermined mobile device 32 to the second portions 36 so as to be removably mounted to the rear portion 14.

The first and second portions may form an L-shape, though other shapes and configurations may be used so long as the two bracket flanges 26 function in accordance with the present invention as described herein. The first portion 34 and/or second portion 36 may vary from set to set of bracket flanges 26 so to make them adaptable to various and changing predetermined mobile devices 32, as long as a distance from the removable fastener 20 to the second portion 36 allows each second portion 36 to protrude through the elongated cutout 18.

As a result, one set of two bracket flanges 26 may be easily swapped out for another set of two bracket flanges 26 to operably engage a new, upgraded predetermined mobile device 32, whereby a user removes the two removable fasteners 20 from the fastener holes of the rear portion 14 when adjusting the new set of two bracket flanges 26 to the new, upgraded predetermined mobile device 32.

The universal mounting system 10 may include two support legs 22 that are pivotally connected to opposing sides of the enclosure 12, so that the enclosure 12 is rotatable along a longitudinal axis perpendicular to the central vertical axis. The two support legs 22 may be dimensioned and adapted to slide into head rest holes provided by a seat body 30.

In certain embodiments, the universal mounting system 10 may be form-fitted into a seat head rest 28.

In certain embodiments, universal mounting system 10 may include a second enclosure (not shown) forming a second enclosure for housing the enclosure 12, wherein a power source be disposed between enclosures, and wherein the power source is configured to power the predetermined mobile device 32.

A method of using the present invention may include the following. The universal mounting system 10 disclosed above may be provided. A user may slide the two supporting legs 22 into the head rest holes of a seat body 30. Then the user may operably engage the two second portions 36 and the predetermined mobile device 32 within the enclosure cavity 16 so as be able to pivot the enclosure 12/head rest 28 about its/their longitudinal axis, positioning the predetermined mobile device 32 at a desired viewing angle. After upgrading their mobile device 32, the user may change the bracket flanges 26 so as to continue to operatively engage the upgraded mobile device 32 within the enclosure cavity 16.

It should be understood, of course, that the foregoing relates to exemplary embodiments of the invention and that modifications may be made without departing from the spirit and scope of the invention as set forth in the following claims.

What is claimed is:

1. A universal mounting system for mounting a mobile device, comprising:
an enclosure forming an enclosure cavity, wherein a front portion of the enclosure is open and an opposing rear portion of the enclosure curves away from the front portion;
two aligned, spaced apart elongated cutouts formed into the rear portion; and
a universal bracket assembly, comprising:
a plurality of brackets flanges, each comprising:
a first portion joined to a second portion, wherein two bracket flanges attach to the rear portion so that each second portion protrudes through one of the two elongated cutouts.

2. The universal mounting system of claim 1, wherein the universal bracket assembly further comprises two removable fasteners for attaching the two first portions to the rear portion.

3. The universal mounting system of claim 2, wherein the universal bracket assembly further comprises a bracket plate sandwiched between the two first portions and the rear portion.

4. The universal mounting system of claim 1, further comprising two support legs pivotally connected to opposing sides of the enclosure, wherein the two support legs are dimensioned and adapted to slide into standard head rest holes of a seat body.

5. The universal mounting system of claim 4, further comprising a head rest formed about the enclosure.

6. The universal mounting system of claim 1, wherein the two elongate cutouts are aligned vertically about a central axis of the rear portion.

7. A universal mounting system for mounting a mobile device, comprising:
an enclosure forming an enclosure cavity, wherein a front portion of the enclosure is open and an opposing rear portion of the enclosure curves away from the front portion;
two elongated cutouts formed into the rear portion, wherein the two cutouts are spaced apart and aligned along a central vertical axis; and
a universal bracket assembly, comprising:
a plurality of brackets flanges, each comprising:
a first portion joined to a second portion, wherein two bracket flanges attach to the rear portion so that each second portion protrudes through one of the two elongated cutouts;
two removable fasteners for attaching the two first portions to the rear portion; and
a bracket plate sandwiched between the two first portions and the rear portion; and
two support legs pivotally connected to opposing sides of the enclosure, wherein the two support legs are dimensioned and adapted to slide into standard head rest holes of a seat body.

8. The universal mounting system of claim 7, further comprising a head rest formed about the enclosure.
